(19) United States
(12) Patent Application Publication
(10) Pub. No.: US 2025/0239851 A1
(43) Pub. Date: Jul. 24, 2025

(54) POWER SHARING SYSTEM, POWER SYSTEM

(71) Applicant: Hitachi, Ltd., Tokyo (JP)

(72) Inventors: Jun TSUNODA, Tokyo (JP); Toru KOUNO, Tokyo (JP)

(21) Appl. No.: 18/960,131

(22) Filed: Nov. 26, 2024

(30) Foreign Application Priority Data
Jan. 18, 2024 (JP) 2024-006173

(51) Int. Cl. H02J 3/00; H02J 3/32; H02J 7/00; H02J 7/35

(52) U.S. Cl. CPC H02J 3/004; H02J 3/32; H02J 7/007182; H02J 7/35; H02J 2300/24

(57) ABSTRACT

To provide a technology allowing for efficient use of electric power generated in a transmission base in a power sharing system that transmits electric power from the power transmission base having a photovoltaic power generation system and electrified equipment to a power receiving base. The power sharing system according to the present invention corrects a power generation predicted value based on the power generation predicted value and a power generation variation amount of a photovoltaic power generation system, and calculates a charging amount for a shared power and the electrified equipment based on a surplus generated power of the photovoltaic power generation system and an allowed charging amount for the electrified equipment.

### CROSS-REFERENCE TO RELATED APPLICATION

The present application claims priority from Japanese application JP2024-006173, filed on Jan. 18, 2024, the content of which is hereby incorporated by reference into this application.

### TECHNICAL FIELD

The present invention relates to a technology of transmitting electric power generated by a photovoltaic power generation system installed in a power transmission base to a power receiving base via a power transmission network.

### BACKGROUND ART

With increasing consciousness toward carbon neutrality of power suppliers, nowadays, a power generation system including a photovoltaic power generation (PV: Photo Voltaic) that uses natural energy and a storage battery juxtaposed therewith is becoming more and more popular. Such a power generation system is also used, by a company equipped with a power generation unit or the like, as a power sharing system capable of supplying (feeding) electric power generated by the power generation system via an electric power network owned by the power company and/or receiving (being supplied with) electric power from another system.

When sharing power from one or more bases, it is required to submit a sharing plan to an administrative organization (e.g., Organization for Cross-regional Coordination of Transmission Operators: OCCTO) before the power transmission is started (e.g., the day before). Furthermore, while the power sharing is performed, the electric power must be transmitted at a predetermined time interval (e.g., every 30 minutes) as planned in advance. In case an actual power transmission deviates from the advanced plan (imbalance), an imbalance charge is generally imposed according to the imbalance power.

Patent Literature 1 listed below describes a technology of adjusting a surplus or shortage of photovoltaic power generation. The Patent Literature describes, for the purpose of “adequately absorbing or supplementing a surplus portion or shortage portion of generated power in an electric power network to which a photovoltaic power generation device is connected,” a technology of “a CEMS server performing a process including: when a prediction starting condition is satisfied (YES at S100), obtaining a predicted value for an amount of solar radiation and its reliability (S102); calculating a predicted value for generated power (S104); when the predicted value for the generated power is larger than required power (YES at S106), if the reliability of the predicted value is high (YES at S108), setting a first target range (S110); if the reliability of the predicted value is low (NO at S108), setting a second target range (S112); when the predicted value for the generated power is equal to or lower than the required power (NO at S106), if the reliability of the predicted value is high (YES at S114), setting a third target range (S116); and if the reliability of the predicted value is low (NO at S114), setting a fourth target range (S118)” (see abstract).

### CITATION LIST

### Patent Literature

Patent Literature 1: Japanese Unexamined Patent Application Publication No. 2023-030792

### SUMMARY OF INVENTION

### Technical Problem

A power transmission base includes, for example, a photovoltaic power generation system as a power generation unit and also includes a storage battery as a power storage unit. Surplus power generated by the photovoltaic power generation system is stored in the power storage unit or transmitted to a power receiving base. In view of stabilizing a power transmission system, the storage capacity is preferably as large as possible. However, a price of a stationary storage battery is generally high, which places a limit on the storage capacity of the stationary storage battery that can be installed in the power transmission base.

On the other hand, portable electrified equipment such as an electric vehicle is also equipped with a storage battery, which can be charged at the power transmission base. Since such as the electrified equipment moves among the bases, though not necessarily charged at the power transmission base, there is a possibility of increasing a capacity for charging at the power transmission base.

In order to suppress the imbalance in the power sharing, it is desirable that a power generating operation by the photovoltaic power generation system is linked to a charge/discharging instruction to the storage battery. This is because the surplus and shortage of the power generation can be adjusted by the storage battery. However, the electrified equipment normally belongs to a control system different from the photovoltaic power generation system (a control system that issues a control instruction to the photovoltaic power generation system does not have a function or authority to control the electrified equipment). With this in mind, even if the electrified equipment can supplement a charging capacity of the stationary storage battery, it is considered desirable not to depend on the charging capacity of the electrified equipment as much as possible to achieve it. This is because the charge/discharging instruction to the electrified equipment can not always be freely executed by a control system.

Such a prior art technology as described in Patent Literature 1 assumes to charge a vehicle (an example of the electrified equipment). On the other hand, how to handle the fact that the charging capacity of the electrified equipment in the power transmission base is not necessarily constant may not be fully considered. If the charging capacity of the electrified equipment is not taken into account, the surplus of the generated power will be wasted, which is not desirable in view of the power efficiency.

The present invention has been made in view of the above-described problem, and it is an object of the present invention to provide a technology allowing for efficient use of electric power generated in a transmission base in a power sharing system that transmits electric power from the power transmission base having a photovoltaic power generation system and electrified equipment to a power receiving base.

### Solution to Problem

A power sharing system according to the present invention corrects a power generation predicted value based on the power generation predicted value and a power generation variation amount of a photovoltaic power generation system, and calculates a charging amount for a shared power and the electrified equipment based on a surplus generated power of the photovoltaic power generation system and an allowed charging amount for the electrified equipment.

### Advantageous Effects of Invention

The power sharing system according to the present invention allows for efficient use of electric power generated by the power transmission base in the power sharing system that transmits electric power from the power transmission base having the photovoltaic power generation system and the electrified equipment to the power receiving base. Objects, configurations, and effects other than the above will be apparent from the description of the following embodiments.

### BRIEF DESCRIPTION OF DRAWINGS

FIG. 1 is a block diagram of a power sharing system 1 according to a first embodiment;

FIG. 2 is a general configuration diagram of a power system according to the first embodiment;

FIG. 3A is a functional block diagram of a prediction calculation unit 2;

FIG. 3B is a functional block diagram of a battery management unit 3;

FIG. 4 shows an example of weather information;

FIG. 5 is a flowchart explaining an operation of the prediction calculation unit 2;

FIG. 6 is a graph illustrating a relation between a cloud amount and a variation amount of generated power;

FIG. 7 is a graph illustrating a relation between voltage output from a storage battery included in electrified equipment and an additionally chargeable capacity;

FIG. 8 is a flowchart explaining a procedure in which the battery management unit 3 calculates an allowed charging amount;

FIG. 9 shows an example result of calculating the allowed charging amount with respect to each power transmission base;

FIGS. 10(1) to 10(4) show an example of correction value data used by the power sharing system 1;

FIG. 11 shows an example of constraint condition data obtained from a memory unit by the power sharing system 1;

FIG. 12 is a flowchart explaining an operation procedure of the power sharing system 1;

FIG. 13 is a graph illustrating a result of correcting a power generation predicted value of a photovoltaic power generation system;

FIG. 14 shows an example of a result of calculating a charging amount based on a corrected predicted power generation;

FIG. 15 shows an example user interface provided by a computing unit 11;

FIG. 16 is a graph illustrating a result of the power sharing system 1 according to a second embodiment correcting the power generation predicted value of the photovoltaic power generation system;

FIG. 17 shows an example of the result of calculating the charging amount based on the predicted power generation after recorrection;

FIG. 18 is a flowchart explaining an operation procedure of the power sharing system 1 according to the second embodiment;

FIG. 19 is a graph illustrating a result of the power sharing system 1 according to a third embodiment correcting the power generation predicted value of the photovoltaic power generation system;

FIG. 20 shows an example of constraint condition data obtained from the memory unit by the power sharing system 1 according to a fourth embodiment; and

FIG. 21 is a configuration diagram of the power sharing system according to the fourth embodiment.

### DESCRIPTION OF EMBODIMENTS

### First Embodiment

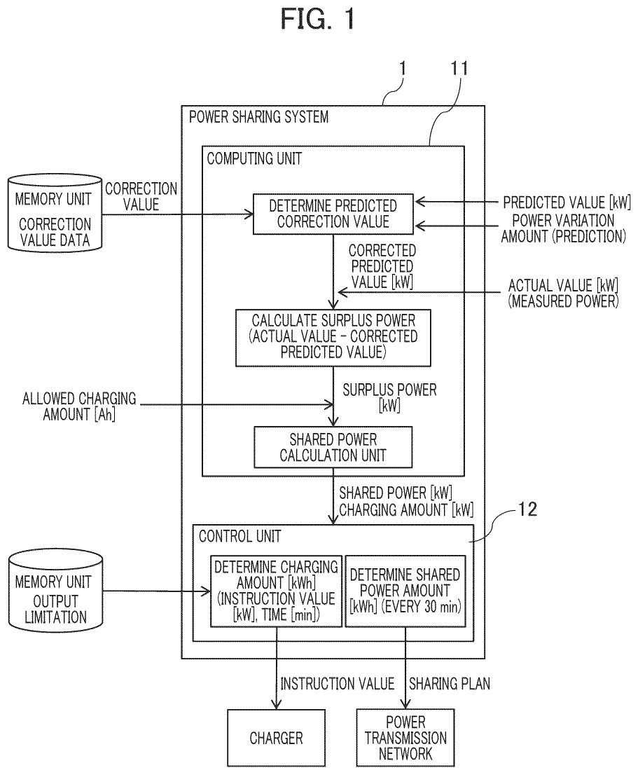

FIG. 1 is a block diagram of a power sharing system 1 according to a first embodiment of the present invention. The power sharing system 1 is a system that transmits power from a power transmission base to a power receiving base. The power sharing system 1 includes a computing unit 11 and a control unit 12. The computing unit 11 calculates a charging amount for charging electrified equipment included in the power transmission base (e.g., equipment that includes a storage battery and that is not stationary like an electric vehicle) and calculates power to be transmitted from the power transmission base to the power receiving base (shared power). The control unit 12 creates a charging instruction for the electrified equipment (when a charger is interposed, a charging instruction for the charger) and creates a sharing plan.

The computing unit 11 receives a power generation predicted value of a photovoltaic power generation system and a power generation variation amount of the photovoltaic power generation system, and corrects a power generation predicted value [kW] based on the same. For the correction, correction value data to be described later is used. The computing unit 11 calculates surplus power [kW] by subtracting the corrected power generation predicted value from an actual generated power [kW] of the photovoltaic power generation system. The computing unit 11 calculates the charging amount [kW] and the shared power [kW] for the electrified equipment based on an allowed charging amount for the electrified equipment and the surplus power. A specific calculation procedure of the computing unit 11 will be described later.

The control unit 12 determines the charging instruction [kW] and a charging time [min] based on an output limitation at the time of charging (output limitation on the charger and input limitation on the electrified equipment), and calculates the charging amount [kWh] for the electrified equipment based on the same. The control unit 12 outputs a charging instruction value to the charger based on the calculated charging amount. The control unit 12 creates the sharing plan for every 30 minutes, for example, based on the shared power calculated by the computing unit 11, and transmits the sharing plan to a power transmission network (administrative organization).

For example, the following operation forms of the power sharing system 1 are conceivable. (1) In a case of implementing the above-described calculations on the day in the sharing period, the sharing plan created by the control unit 12 is transmitted to the power transmission network no later than one hour before the start of sharing. The charging instruction value corresponding to the latest sharing plan is transmitted to the charger. (2) In a case of implementing the above-described calculations on the day before the sharing period, the computing unit 11 calculates the instruction value based on the sharing plan made the day before because the computing unit 11 cannot obtain the actual generated power.

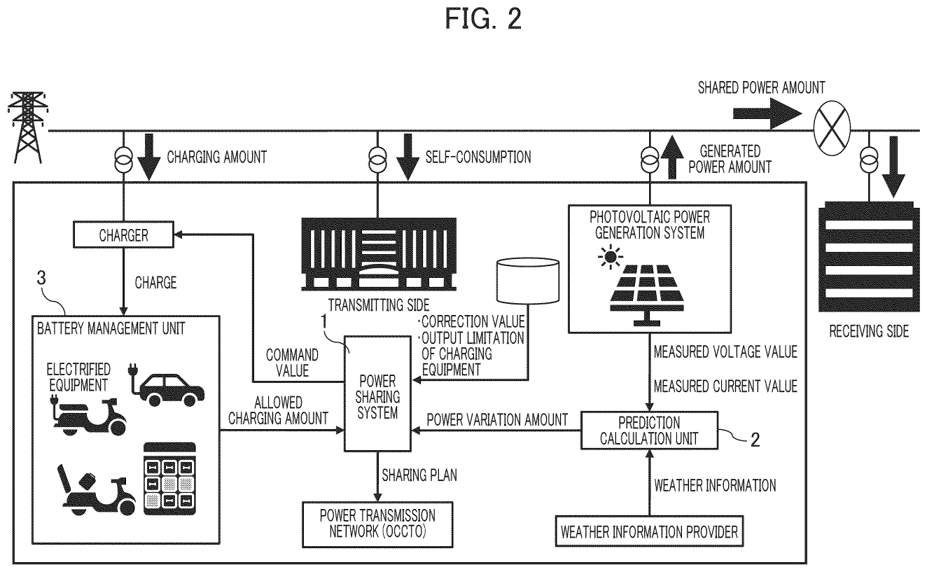

FIG. 2 is a general configuration diagram of a power system according to the first embodiment. The power transmission base includes, in addition to the power sharing system 1, a photovoltaic power generation system, electrified equipment, a charger, a prediction calculation unit 2, a battery management unit 3, and the like. The prediction calculation unit 2 calculates the power generation predicted value of the photovoltaic power generation system, the power generation variation amount of the photovoltaic power generation system, and the like, and outputs them to the power sharing system 1. The battery management unit 3 manages the storage battery included in the electrified equipment. The battery management unit 3 calculates the allowed charging amount for the storage battery included in the electrified equipment and informs the power sharing system 1 of the result. Details of the prediction calculation unit 2 and the battery management unit 3 will be described later. The power system according to the first embodiment is constituted by combining the power transmission base and the power receiving base.

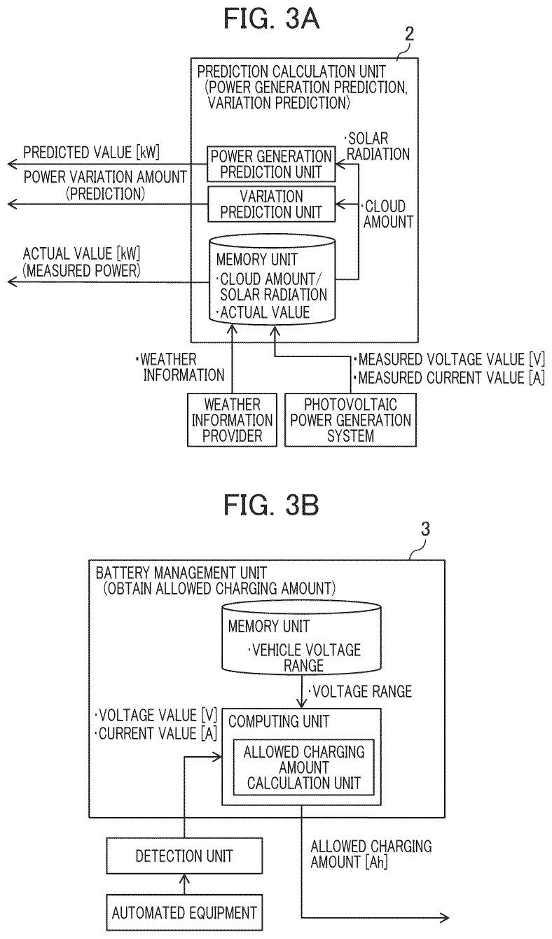

FIG. 3A is a functional block diagram of a prediction calculation unit 2. The prediction calculation unit 2 includes a power generation prediction unit, a variation prediction unit and the memory unit. The memory unit stores therein weather information (predicted values such as a cloud amount, an amount of solar radiation, and the like) that the prediction calculation unit 2 obtained from a weather information provider. In addition, the memory unit stores therein measured values (actual values) of output voltage and output current of the photovoltaic power generation system, respectively, and also actual generated power values [kW] based on the measured values. The power generation prediction unit calculates the power generation predicted value of the photovoltaic power generation system. The variation prediction unit predicts the power generation variation amount of the photovoltaic power generation system. The prediction calculation unit 2 outputs these values to the power sharing system 1.

FIG. 3B is a functional block diagram of a battery management unit 3. The battery management unit 3 includes the computing unit and the memory unit. The memory unit stores therein voltage range data that describes a range of output voltage from a battery included in the electrified equipment (to be described later). The computing unit obtains detected values of the output voltage and output current from the battery included in the electrified equipment, respectively. A detection unit that detects them may be a sensor included in the electrified equipment, or may be an external sensor connected to the electrified equipment. The computing unit calculates the allowed charging amount allowed to be charged to the electrified equipment using these data. The battery management unit 3 informs the sharing system 1 of the calculation result of the allowed charging amount.

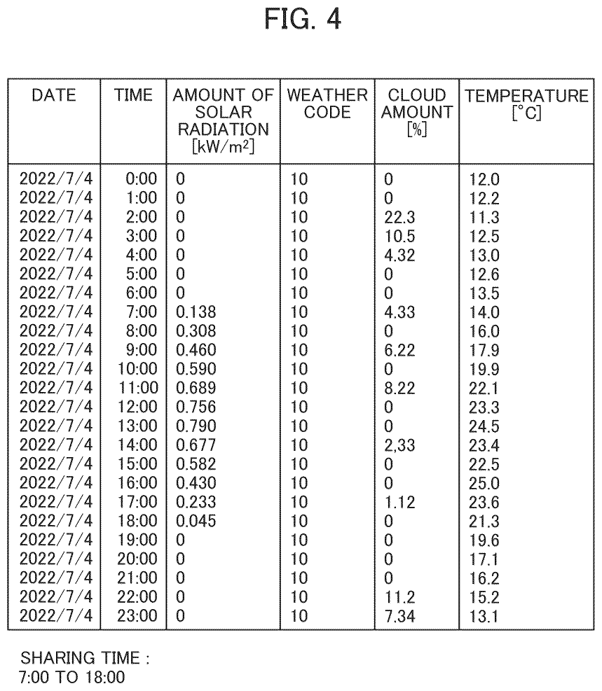

FIG. 4 shows an example of weather information. The weather information describes histories of the amount of solar radiation, the cloud amount, a weather code, temperature, and the like with respect to each time period.

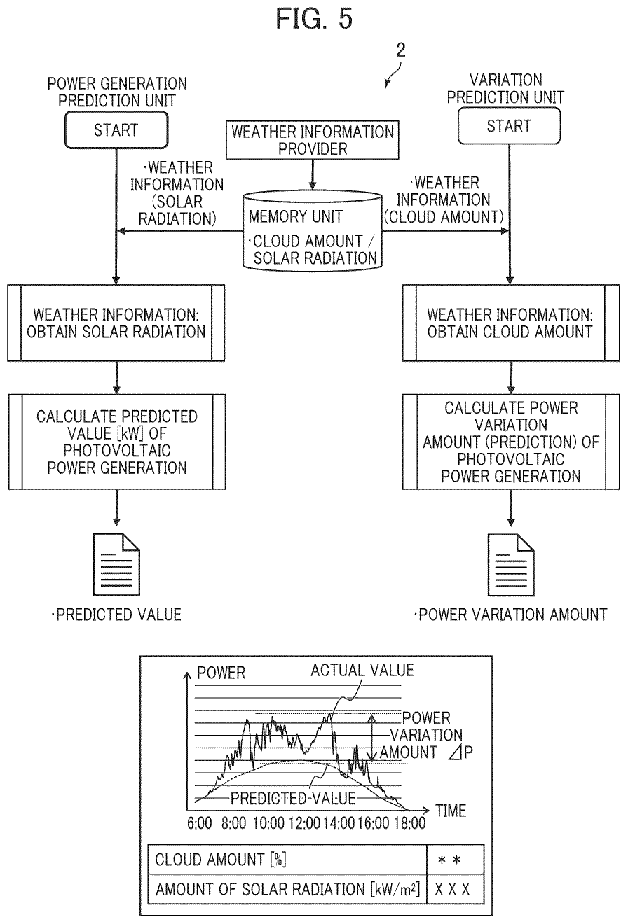

FIG. 5 is a flowchart explaining an operation of the prediction calculation unit 2. The power generation prediction unit calculates a power generation prediction of the photovoltaic power generation system based on the prediction amount of solar radiation described in the weather information. A calculation formula of the power generation prediction based on the amount of solar radiation is commonly used, and therefore not described herein in detail. The variation prediction unit predicts temporal variation of the photovoltaic power generation system based on the cloud amount described in the weather information. The generated power of the photovoltaic power generation system is known to be affected by the cloud amount, specifically to have a larger temporal variation when the weather is cloudy (largely varies every moment) and a smaller temporal variation when the weather is sunny or rainy (varies generally corresponding to a solar radiation prediction). The variation prediction unit machine-learns the relation between the cloud amount and the variation amount of the generated power in advance and predicts the variation amount of the generated power based on the result. The prediction may be made using other suitable techniques.

The variation amount of the generated power is a representation of a difference of actual generated power against electric power assumed to be generated by a solar battery with a certain amount of solar radiation with respect to each time point. For example, the power variation amount in a graph at the bottom of FIG. 5 indicates the difference between the power generation prediction and the actual generated power at a time point around 14:00.

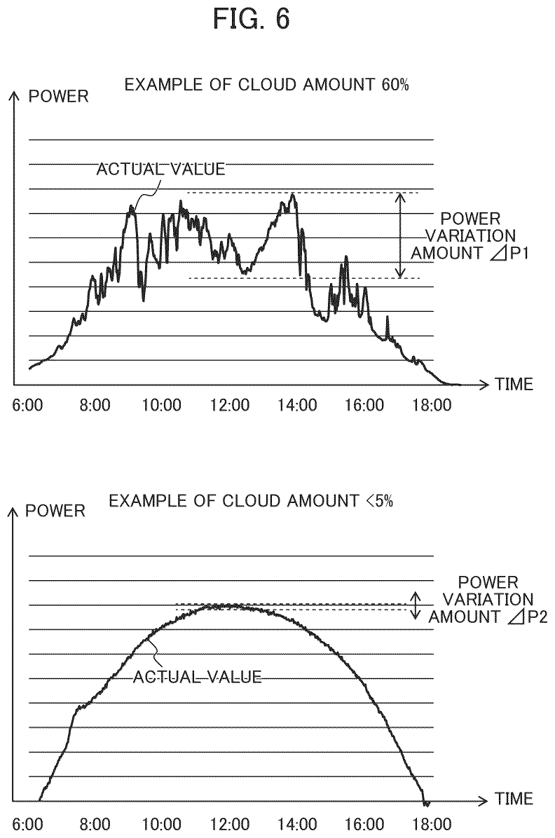

FIG. 6 is a graph illustrating a relation between a cloud amount and a variation amount of generated power. As shown at the top of FIG. 6, on a day with a large cloud amount, the generated power of the photovoltaic power generation system largely varies with respect to each time period. In contrast, as shown at the bottom of FIG. 6, on a day with a small cloud amount, the generated power changes over time generally along the temporal change of the amount of solar radiation, and the power variation amount with respect to each time period is small. The variation prediction unit predicts the variation amount of the generated power of the photovoltaic power generation system based on such a relation. Also on a day with a very large cloud amount (e.g., rainy), the power variation amount is small because the generated power is mostly as predicted.

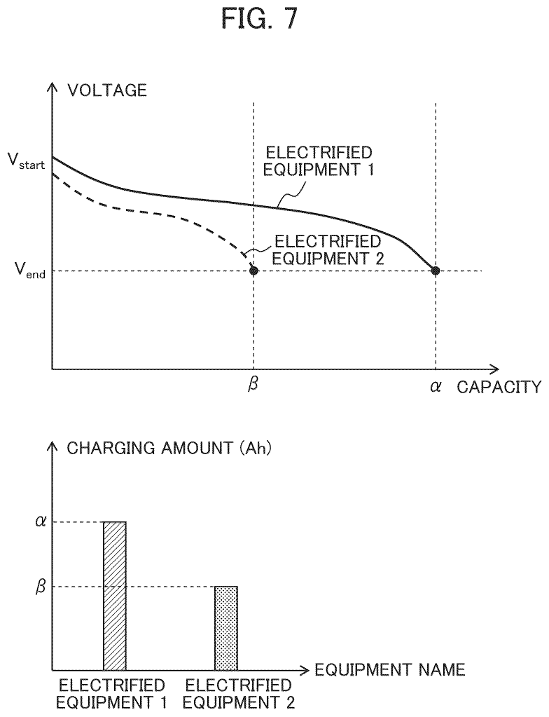

FIG. 7 is a graph illustrating a relation between voltage output from a storage battery included in electrified equipment and an additionally chargeable capacity. The storage battery has high voltage and a small additionally chargeable capacity (i.e., available capacity) in a nearly full-charged state, but as it is discharged, the voltage drops and the additionally chargeable capacity increases. The relation between the voltage and the additionally chargeable capacity varies for each storage battery (i.e., for each electrified equipment). The voltage range data held by the battery management unit 3 describes such a relation as in FIG. 7 with respect to each electrified equipment.

The battery management unit 3 obtains respective detected values of the output voltage and the output current of the storage battery included in the electrified equipment. The battery management unit 3 obtains the available capacity of the electrified equipment by referencing the voltage range data shown at the top of FIG. 7 using the obtained output voltage. The battery management unit 3 uses the available capacity as the allowed charging amount for the electrified equipment. When it is difficult to prepare the data at the top of FIG. 7 in advance, the available capacity may be calculated by the time integration of the output voltage and the output current.

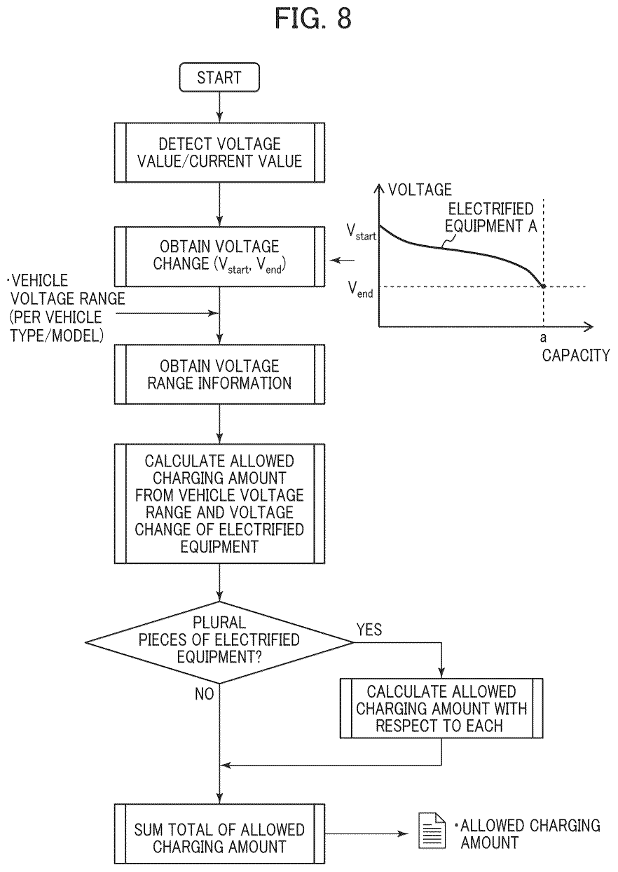

FIG. 8 is a flowchart explaining a procedure in which the battery management unit 3 calculates an allowed charging amount. The battery management unit 3 obtains respective detected values of the output voltage and the output current of the storage battery included in the electrified equipment. The battery management unit 3 calculates the allowed charging amount for each electrified equipment by referencing the voltage range data using the obtained output voltage. If the power transmission base includes a plurality of pieces of electrified equipment, the allowed charging amounts of respective electrified equipment are summed and the result is used as the allowed charging amount for the power transmission base.

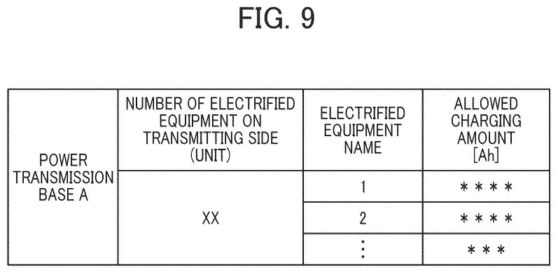

FIG. 9 shows an example result of calculating the allowed charging amount with respect to each power transmission base. The allowed charging amount for the power transmission base can be represented as a sum of the allowed charging amounts of the electrified equipment. Details thereof can be described with respect to each electrified equipment as shown in FIG. 9.

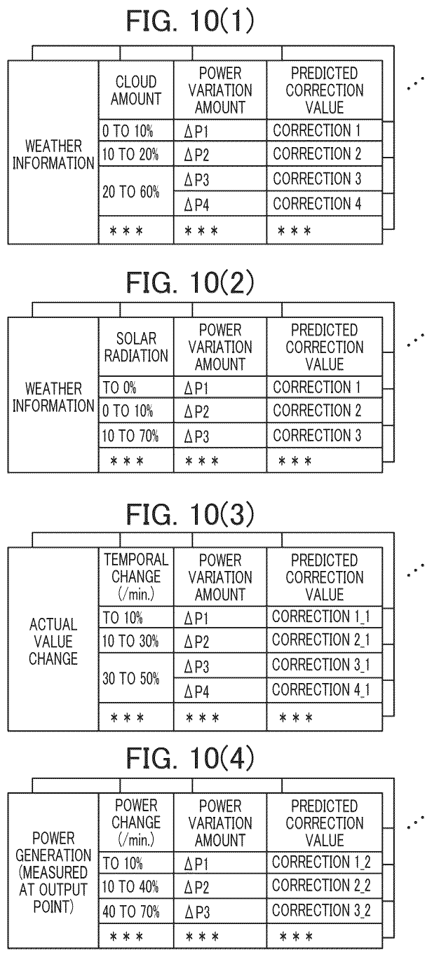

FIGS. 10(1) to 10(4) show an example of correction value data used by the power sharing system 1. The variation of the generated power of the photovoltaic power generation system may be calculated by the technique as described with reference to FIGS. 5 to 6, or may be estimated by other techniques. When using the technique described with reference to FIGS. 5 to 6, the power variation amount is estimated on the basis of the cloud amount in the weather information as shown in FIG. 10(1). The following techniques are conceivable as other examples.

The power variation amount may be estimated on the basis of the amount of solar radiation in the weather information as shown in FIG. 10 (2). In this case, the relation between the amount of solar radiation and the variation amount of the generated power may be learned in advance, or the like. The power variation amount may also be estimated on the basis of the actual generated power of the photovoltaic power generation system as shown in FIG. 10(3). In this case, for example, the relation between the temporal change rate of the actual generated power and the variation amount of the generated power may be learned in advance. The power variation amount may also be estimated on the basis of an actual performance (measured value) measured at an output point of the photovoltaic power generation system as shown in FIG. 10(4). In this case, the relation between the temporal change rate of the actual generated power and the variation amount of the generated power may be learned in advance, and the like.

The correction value data specifies a correction value for the power generation prediction with respect to each power variation amount calculated as described above. In other words, once the power variation amount is known, the correction value for the power generation prediction can be determined by referencing a lookup table as shown in FIGS. 10(1) to 10(4). This technique for determining the correction value is merely one example, and other suitable techniques may be used than the lookup table. In the following, the lookup table as shown in FIGS. 10(1) to 10(4) shall be used.

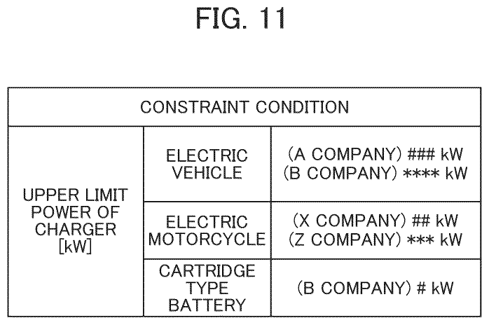

FIG. 11 shows an example of constraint condition data obtained from a memory unit by the power sharing system 1. The constraint condition data describes the output limitation on the charger that charges the electrified equipment. For example, an upper limit of the output power when the charger charges the electrified equipment is described with respect to each type of the electrified equipment. The control unit 12 can calculate the charging instruction using this constraint condition.

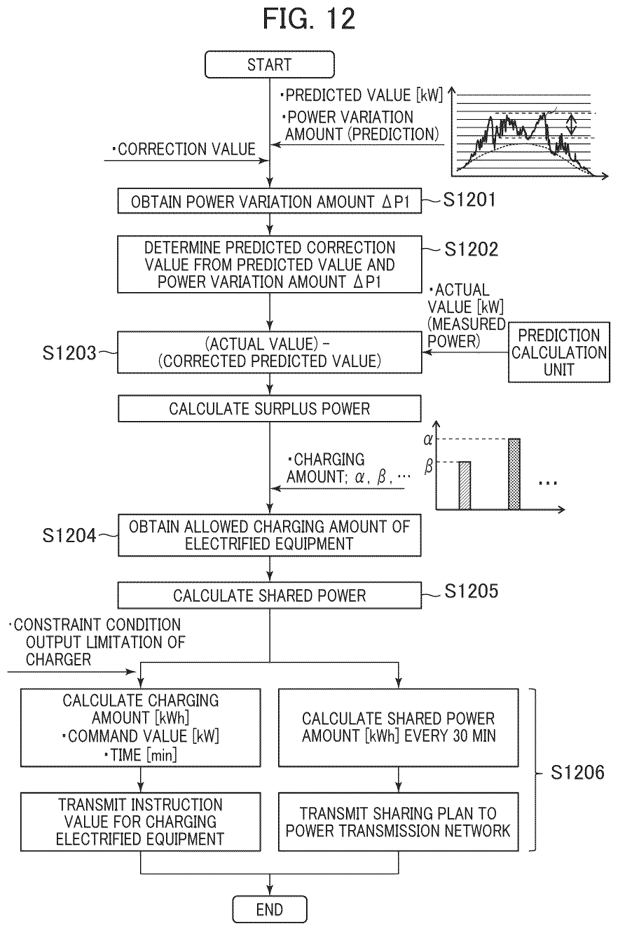

FIG. 12 is a flowchart explaining an operation procedure of the power sharing system 1. Each step shown in FIG. 12 will be described below.

S1201: The computing unit 11 obtains the power generation predicted value of the photovoltaic power generation system and an estimation result of the variation amount of the generated power respectively from the prediction calculation unit 2. The computing unit 11 obtains the correction value data (the data described in FIGS. 10(1) to 10(4)) stored in the memory unit.

S1202: The computing unit 11 obtains a correction amount for the power generation prediction by referencing the correction value data using the power variation amount. The computing unit 11 calculates the corrected power generation predicted value by applying the obtained correction amount to the power generation prediction. Significance and specific examples of the correction amount will be described using an example to be stated below.

S1203: The computing unit 11 obtains the actual generated power value (measured value) of the photovoltaic power generation system from the prediction calculation unit 2. The computing unit 11 calculates the surplus generated power of the photovoltaic power generation system by subtracting the corrected power generation predicted value calculated at S1202 from the actual generated power value.

S1204: The computing unit 11 obtains the allowed charging amount with respect to each electrified equipment from the battery management unit 3.

S1205: The computing unit 11 calculates the shared power to be transmitted to the power receiving base by referencing the sharing plan created in advance, for example. The shared power may be used as it is, if there is no change from the preplanned value. To change the plan before submitting it, a planned value after the change is calculated and used as the shared power in this step. If there is a self-consumed portion in the power transmission base, the shared power is calculated by subtracting the portion from the power generation prediction.

S1205: Supplement: Although the surplus power should be used for charging the electrified equipment in principle, the power from the power transmission system may be used for charging in addition to the surplus power. Only a part of the surplus power may be used for charging and the remainder may be supplemented by the power transmission system for charging. If the allowed charging amount exceeds the surplus power, the shortage of the allowed charging amount may be supplemented by the power transmission system, or only a part of the allowed charging amount may be charged without supplement. That is, there is no need for satisfying the entire allowed charging amount, and furthermore, the power used for charging may be supplied from the surplus power or other sources. In any case, this step only requires to obtain the surplus power and the allowed charging amount in advance and to calculate the shared power using these values as indices.

S1206: Part 1: The control unit 12 obtains the output limitation of the charger from the constraint condition data. The control unit 12 calculates the charging instruction value and the charging time (i.e., the charging amount) for the charger according to the allowed charging amount and the output limitation with respect to each electrified equipment as obtained at S1204. The control unit 12 transmits the calculated charging instruction value to the charger.

S1206: Part 2: The control unit 12 creates the sharing plan by calculating the shared power for every 30 minutes according to the shared power calculated at S1205. The control unit 12 transmits the created sharing plan to the power transmission network (administrative organization).

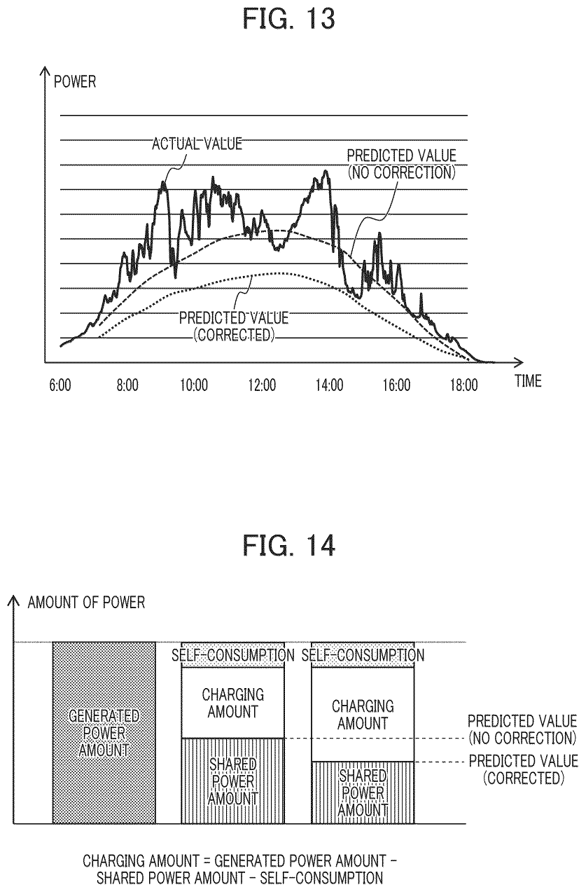

FIG. 13 is a graph illustrating a result of correcting a power generation predicted value of a photovoltaic power generation system. The computing unit 11 corrects the power generation prediction as shown in FIG. 13 by applying such a correction as adjusting the power generation prediction downward. The surplus generated power is calculated by subtracting the power generation prediction from the actual generated power. If the surplus generated power is small (i.e., if the actual generated power and power generation prediction are substantially equal), the generated power of the photovoltaic power generation system may become the shared power almost as it is. Therefore, if the power generation prediction is close to the actual generated power, the generated power of the photovoltaic power generation system is used as the shared power, and the surplus can be used as charging power for the electrified equipment. However, if the generated power varies largely as shown in FIG. 13, a separation between the power generation prediction and the actual generated power may become larger, and the actual generated power may possibly become lower than the power generation prediction. In that case, the electric power available for charging the electrified equipment may lack.

Taking into account that the electrified equipment may move between bases and the allowed charging amount in the power transmission base is not constant, it is considered desirable to secure sufficient surplus power available for charging the electrified equipment. Therefore, in the present invention, more surplus power is secured by adjusting the power generation prediction downward. This allows the actual generated power to be higher than the power generation prediction to generate the surplus power and secure electric power available for charging the electrified equipment. The corrected predicted value in FIG. 13 indicates this.

FIG. 14 shows an example of a result of calculating a charging amount based on a corrected predicted power generation. Correcting the power generation prediction downward increases the power available for charging the electrified equipment on one hand and decreases the shared power on the other hand. FIG. 14 shows their examples by comparing the cases in which the power generation prediction is corrected and not corrected.

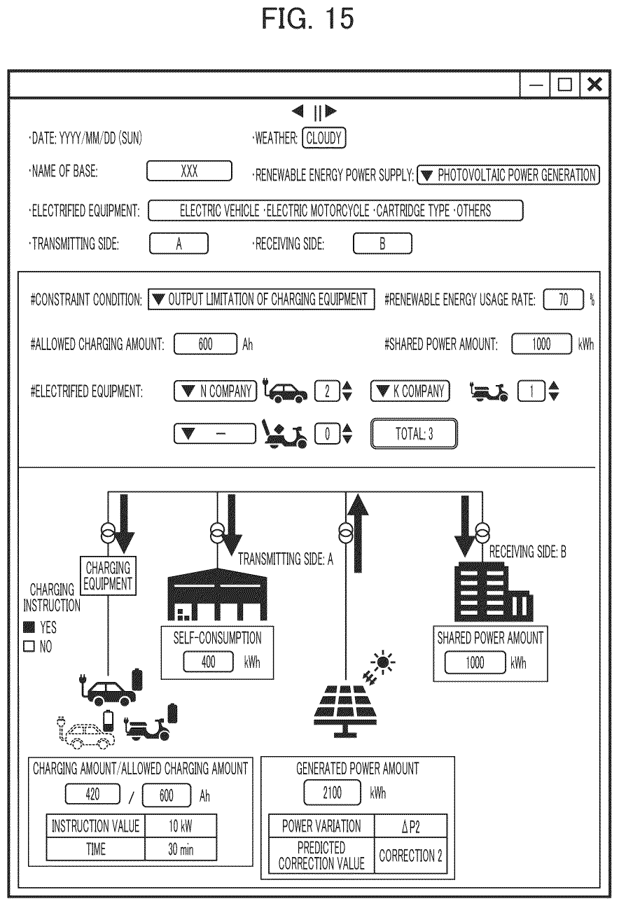

FIG. 15 shows an example user interface provided by a computing unit 11. The user interface can present the result of calculations performed by the computing unit 11 and the control unit 12. For example, the calculation results such as the shared power, the charging amount, and the like can be presented with respect to each base.

### Second Embodiment

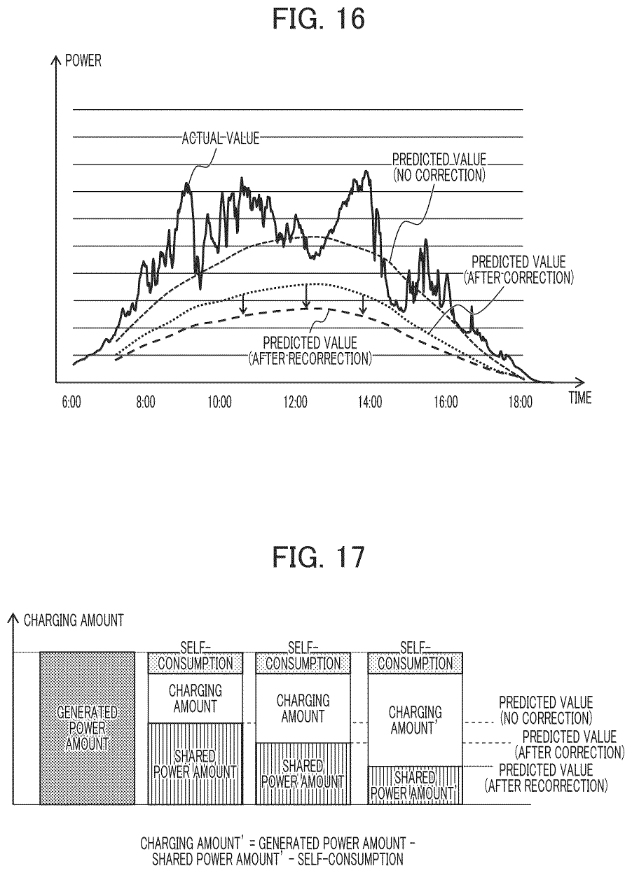

FIG. 16 is a graph illustrating a result of the power sharing system 1 according to a second embodiment of the present invention correcting the power generation predicted value of the photovoltaic power generation system. Although the allowed charging amount for the electrified equipment should match the allowed charging amount indicated by a measuring instrument or the like included in the electrified equipment itself in principle, the allowed charging amount calculated by the battery management unit 3 based on an actual measurement value may be far from the presented value. For example, such cases can be conceived in which the charging capacity is decreased by degradation of the storage battery or in which there is a measurement error. In this case, the computing unit 11 may further correct the power generation prediction that was once corrected. Other configurations are the same as in the first embodiment.

For example, when the allowed charging amount calculated by the battery management unit 3 is larger than a presented value, the power generation prediction is recorrected so as to make the charging amount for the electrified equipment larger. Since the charging amount for the electrified equipment is allocated from the surplus power, the surplus power may be increased in order to increase the charging amount. That is, the power generation prediction may be recorrected downward. When the calculated allowed charging amount is smaller than the presented value, it means that only a small portion of the surplus power can be charged to the electrified equipment, and therefore it is desirable to use the surplus power as the shared power. Accordingly, in this case, the power generation prediction may be adjusted upward.

FIG. 17 shows an example of the result of calculating the charging amount based on the predicted power generation after recorrection. Illustrated here is an example of increasing the charging amount for the electrified equipment by correcting the power generation prediction downward at the time of recorrection.

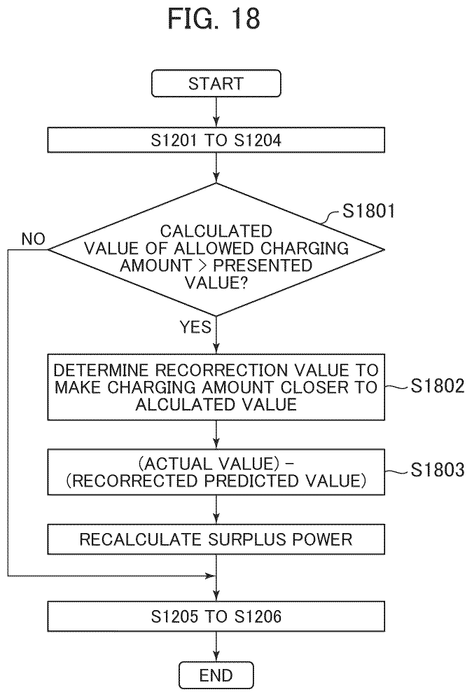

FIG. 18 is a flowchart explaining an operation procedure of the power sharing system 1 according to the second embodiment. New steps S1801 to S1803 are added to the flowchart described in the first embodiment between S1204 and S1205. Other parts are the same as in the first embodiment.

S1801: The computing unit 11 compares a calculated value of the allowed charging amount obtained at S1204 with the presented value of the allowed charging amount presented by the electrified equipment. If the presented value is larger, the process skips to S1205. Otherwise, the process proceeds to S1802. If the difference between the two is very small, the process may skip to S1205. That is, if the difference derived by subtracting the presented value from the calculated value is equal to or larger than a threshold value, the process proceeds to S1802, and otherwise (if both are close to each other) the process may skip to S1205.

S1802 to S1803: The computing unit 11 recorrects the power generation prediction so as to make the charging amount for the electrified equipment closer to the calculated value obtained at S1204 (S1802). The computing unit 11 recalculates the surplus power by subtracting the recorrected power generation prediction from the actual generated power (S1803).

### Third Embodiment

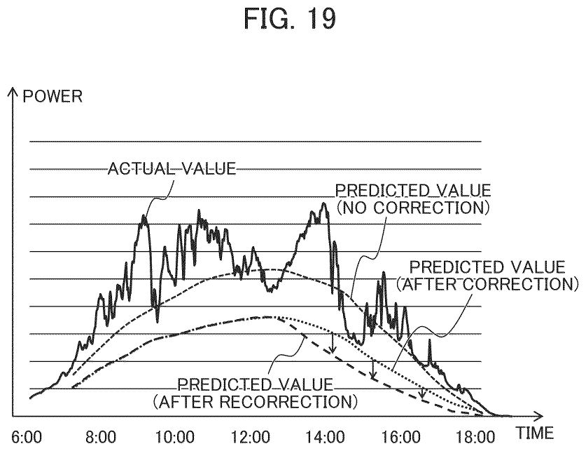

FIG. 19 is a graph illustrating a result of the power sharing system 1 according to a third embodiment of the present invention correcting the power generation predicted value of the photovoltaic power generation system. The allowed charging amount for the electrified equipment may sometimes change over time. Accordingly, the allowed charging amount calculated by the battery management unit 3 based on the actual measurement value also changes over time. In this case, the computing unit 11 may further correct the power generation prediction that was once corrected. Other configurations are the same as in the first embodiment.

For example, if the allowed charging amount after a certain time point increased more than a value calculated first, the power generation prediction is recorrected so as to make the charging amount for the electrified equipment larger. Specifically, as in the second embodiment, the power generation prediction after the time point may be recorrected downward. FIG. 19 shows an example of recorrecting the power generation prediction after 12:00 downward. The procedure of the recorrection is the same as in the second embodiment except that the power generation prediction after the time point is corrected.

### Fourth Embodiment

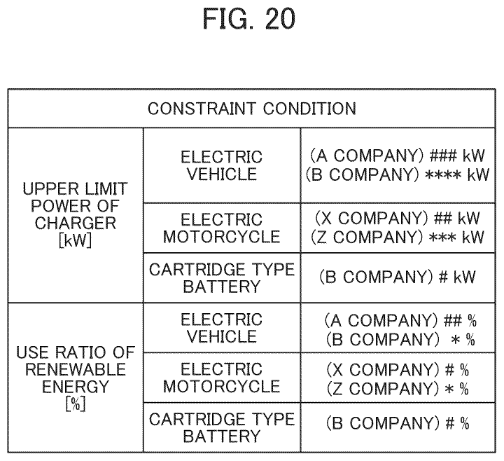

FIG. 20 shows an example of constraint condition data obtained from the memory unit by the power sharing system 1 according to a fourth embodiment of the present invention. Among the power generated by the photovoltaic power generation system, a minimum ratio to be used to charge the electrified equipment may be specified as a use ratio constraint. Data at the bottom of FIG. 20 is an example thereof. For example, if the use ratio constraint is 50%, at least 50% of the generated power must be used for charging any electrified equipment. In this case, the power sharing system 1 (control unit 12) generates the charging instruction so as to charge at least the minimum power to the electrified equipment.

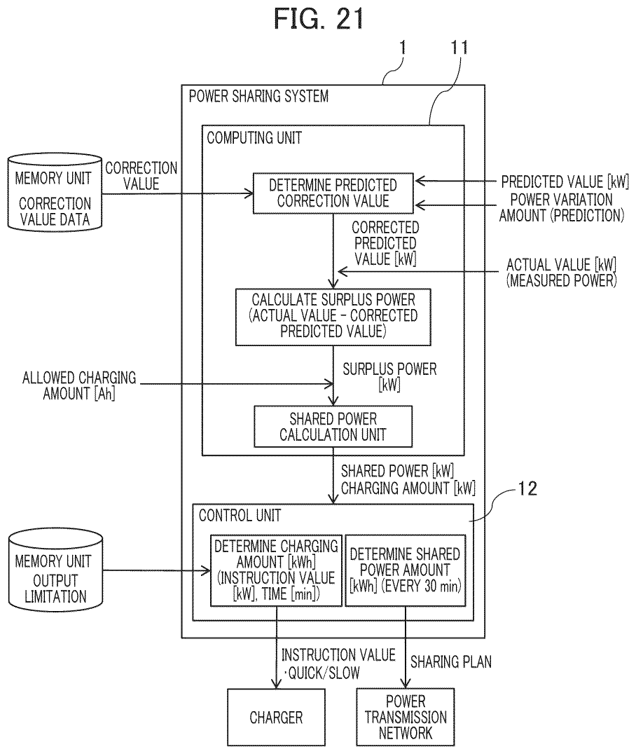

FIG. 21 is a configuration diagram of the power sharing system according to the fourth embodiment. The control unit 12 may indicate a charging rate (i.e., size of charged current) when the charging instruction is output to the charger. In consideration of variation of the generated power, for example, such a usage can be conceived as to indicate a slow charge when there is enough time until time point planned to operate the electrified equipment and to quickly complete charging by a quick charge when the power variation is large. Other configurations are the same as in the above embodiments.

### Modification of Present Invention

The present invention is not limited to the above-described embodiments, and further includes various modifications. For example, the embodiments described above have been described in detail to simply describe the present disclosure, and are not necessarily required to include all the described configurations. In addition, part of the configuration of one embodiment can be replaced with the configurations of other embodiment, and in addition, the configuration of the one embodiment can also be added with the configurations of other embodiments. In addition, part of the configuration of each of the embodiments can be subjected to addition, deletion, and replacement with respect to other configurations.

In the above-described embodiments, it is desirable that the calculates (updates) the charging instruction value more frequently than calculating the sharing plan. This is because it is believed that the charging instruction often occurs at a shorter interval as compared to the sharing plan that is typically made for every 30 minutes.

In the above-described embodiments, each functional unit (e.g., the computing unit 11 and the control unit 12) included in the power sharing system 1, the prediction calculation unit 2, and the battery management unit 3 may be configured by hardware such as a circuit device equipped with these functions, or may be configured by an arithmetic unit such as a CPU (Central Processing Unit) executing software equipped with these functions.

In the above-described embodiments, the prediction calculation unit 2 may be configured as a part of the power sharing system 1, or may be configured as a functional unit separate from the power sharing system 1.

In the above-described embodiments, when adjusting the power generation prediction downward, it is desirable to correct the power generation prediction so that the corrected power generation prediction is less than the generated power. It is noted, however, that this does not necessarily apply when the charging amount for the electrified equipment is supplemented by any other source than the power generation from the photovoltaic power generation system.

### List of Reference Signs

1: power sharing system
11: computing unit
12: control unit
2: prediction calculation unit
3: battery management unit

1. A power sharing system that transmits electric power generated by a photovoltaic power generation system installed in a power transmission base to a power receiving base via a power transmission network, including:
a computing unit that calculates a charging amount to be charged to electrified equipment in the power transmission base and a shared power to be transmitted from the power transmission base to the power receiving base; and
a control unit that creates a charging instruction for the electrified equipment and a power-sharing plan for sharing from the power transmission base to the power receiving base,
wherein the computing unit corrects a predicted value of generated power of the photovoltaic power generation system based on a variation amount of the generated power of the photovoltaic power generation system,
wherein the computing unit calculates a surplus generated power of the photovoltaic power generation system based on the corrected predicted value and an actual value of the generated power of the photovoltaic power generation system,
wherein the computing unit calculates the charging amount and the shared power based on the surplus generated power and an allowed charging amount for the electrified equipment, and
wherein the control unit creates the charging instruction and the power-sharing plan based on the charging amount calculated by the computing unit and the power-sharing plan calculated by the computing unit.

2. The power sharing system according to claim 1,
wherein the computing unit calculates the predicted value from an amount of solar radiation described in weather prediction data,
wherein the computing unit calculates the variation amount from a cloud amount described in weather prediction data, and
wherein the computing unit corrects the predicted value based on the predicted value calculated from the amount of solar radiation and the variation amount calculated from the cloud amount.

3. The power sharing system according to claim 1,
wherein the computing unit calculates the predicted value from an amount of solar radiation described in weather prediction data,
wherein the computing unit calculates the variation amount using at least any of an actual generated power of the photovoltaic power generation system or a measured value obtained by measuring the actual generated power at an output point of the photovoltaic power generation system, and
wherein the computing unit corrects the predicted value based on the variation amount calculated from the predicted value calculated from the amount of solar radiation and the actual generated power or the measured value.

4. The power sharing system according to claim 1,
wherein the computing unit obtains voltage range data that describes a correspondence relation between an output voltage of a battery included in the electrified equipment and the allowed charging amount, and
wherein the computing unit identifies the allowed charging amount by referencing the voltage range data using an actual measurement value of the output voltage.

5. The power sharing system according to claim 1,
wherein the computing unit calculates the charging amount in the power transmission base by adding up the allowed charging amounts of one or more of the electrified equipment to be charged in the power transmission base.

6. The power sharing system according to claim 1,
wherein the computing unit adjusts the predicted value downward so that an actual generated power of the photovoltaic power generation system may be higher than the predicted value based on the predicted value of the photovoltaic power generation system and the variation amount of the generated power of the photovoltaic power generation system.

7. The power sharing system according to claim 1,
wherein the control unit obtains constraint condition data that describes an upper limit power to be output by a charger that charges the electrified equipment, and
wherein the control unit sets an upper limit value of the charging instruction according to the upper limit power described in the constraint condition data.

8. The power sharing system according to claim 6,
wherein the computing unit obtains a presented value of the allowed charging amount presented by a measuring instrument included in the electrified equipment, and
wherein the computing unit further corrects the downward corrected predicted value downward when a difference derived by subtracting the presented value from the calculated value is equal to or larger than a threshold value.

9. The power sharing system according to claim 1,
wherein the computing unit obtains a time change of the allowed charging amount, and
wherein the computing unit recorrects the predicted value so that the allowed charging amount having changed due to the time change can be filled with the surplus generated power.

10. The power sharing system according to claim 1,
wherein the control unit obtains constraint condition data that describes a minimum value of a ratio of power to be allotted to the electrified equipment with respect to the power generated by the photovoltaic power generation system, and
wherein the control unit generates the charging instruction so as to allot a ratio of the power generated by the photovoltaic power generation system to the power to be charged to the electrified equipment, the ratio being higher than the minimum value.

11. The power sharing system according to claim 1,
wherein the control unit indicates a charging rate for the electrified equipment in the charging instruction.

12. The power sharing system according to claim 1,
wherein the control unit updates the charging instruction more frequently than updating the power-sharing plan.

13. A power system including:
a power sharing system according to claim 1;
a prediction calculation unit that calculates the predicted value and the variation amount; and
a battery management unit that calculates the allowed charging amount.

14. The power system according to claim 13,
wherein the power system is constituted by the power transmission base and the power receiving base, and
wherein the photovoltaic power generation system is arranged in the power transmission base.
